(19) United States
(12) Patent Application Publication
(10) Pub. No.: US 2006/0047390 A1
(43) Pub. Date: Mar. 2, 2006

(54) Method for adapting to the lane width in a lane keeping support system

(76) Inventors: Michael Scherl, Bietigheim (DE); Michael Weilkes, Sachsenheim (DE); Lutz Buerkle, Leonberg (DE); Tobias Rentschler, Pforzheim (DE)

Correspondence Address: KENYON & KENYON, ONE BROADWAY, NEW YORK, NY, 10004, US

(21) Appl. No.: 11/186,843

(22) Filed: Jul. 20, 2005

(30) Foreign Application Priority Data
Jul. 31, 2004 (DE) 10 2004 037 298.5

(51) Int. Cl. B62D 6/00

(52) U.S. Cl. 701/41; 701/300

(57) ABSTRACT

A method for adapting a steering-wheel torque, driver-independently exerted on the steering wheel, in a lane-keeping support system of a motor vehicle includes determining a deviation variable that characterizes the lateral vehicle deviation from an ideal line, and exerting a driver-independent steering wheel torque on the steering wheel as a function of the determined deviation variable. In this manner, the torque is adapted to the lane width.

### FIELD OF THE INVENTION

The present invention relates to a method for adapting a steering wheel torque, which is exerted driver-independently on the steering wheel, in a lane-keeping support system of a motor vehicle.

### BACKGROUND INFORMATION

A lateral control system for a motor vehicle is described in published German patent document DE 102 10 548, which control system includes a sensor device for detecting the vehicle's actual position in relation to the boundaries of the traveled lane, an input device for a setpoint value of the lateral position, and a processing device for outputting an output signal determined by a comparison of the setpoint value and the actual position. The input device has a setting element for enabling manual setting of a lateral deviation of the setpoint value from the center of the lane.

### SUMMARY OF THE INVENTION

The present invention provides a method for adapting a steering wheel torque, which is exerted driver-independently on the steering wheel, in a lane-keeping support system of a motor vehicle. In accordance with the method of the present invention, a deviation variable is determined, which characterizes the lateral vehicle deviation or the vehicle trajectory from an ideal line, and a driver-independent steering wheel torque is exerted on the steering wheel as a function of the deviation variable. In accordance with the present invention, the lane width is determined and the torque is adapted to the lane width (or the steering wheel torque additionally depends on the lane width). This makes it possible to use a lane-keeping support system for lanes having different widths.

In accordance with an example embodiment of the present invention, the ideal line for the vehicle travel is assumed to be the center of the traveled lane. This ensures that the vehicle is guided in the center of the lane.

In accordance with an example embodiment of the present invention, the deviation variable represents the vehicle's lateral displacement from the center of the lane or the difference between the ideal line and the actual vehicle trajectory.

In accordance with an example embodiment of the present invention, no steering wheel torque is exerted when the deviation variable is less than or equal to a first limiting value, and a steering wheel torque is exerted when the deviation variable exceeds the first limiting value. This steering wheel torque may be a torque which monotonically increases with the deviation variable, i.e., the steering wheel torque increases along with an increasing deviation variable. There may also be a steering wheel torque which increases linearly with respect to the deviation variable.

In accordance with an example embodiment of the present invention, no steering wheel torque is exerted when the deviation variable is less than or equal to a first limiting value; a steering wheel torque, which monotonically increases with the deviation variable, is exerted when the deviation variable exceeds a first limiting value and falls short of a second limiting value; and the steering wheel torque is maintained at a constant value when the deviation variable is greater than or equal to the second limiting value. It is possible through the neutral zone to output a steering wheel torque only in the event of acute danger of departing the lane, thereby avoiding patronizing of the driver to the greatest possible extent. The steering wheel torque is directed in such a way that it is aimed to reduce the deviation variable.

An example embodiment of the present invention provides that the first limiting value is less than the second limiting value.

An example embodiment of the present invention provides that a steering wheel torque, which linearly increases with the deviation variable, is exerted in the event that the deviation variable exceeds the first limiting value and falls short of a second limiting value.

An example embodiment of the present invention provides that the first limiting value is dependent on the determined lane width.

An example embodiment of the present invention provides that the first limiting value increases along with the increasing lane width, thereby making it possible to allow a greater neutral zone with a wider lane.

In accordance with example embodiment of the present invention, the first limiting value does not increase linearly with the lane width when the lane width falls short of a reference value, but increases linearly with the lane width when the lane width exceeds a reference value.

An example embodiment of the present invention provides that the second limiting value is dependent on the determined lane width.

An example embodiment of the present invention provides that the second limiting value increases with increasing lane width.

In accordance with an example embodiment of the present invention, the second limiting value does not increase linearly with the lane width when the lane width falls short of a reference value, but increases linearly with the lane width when the lane width exceeds a reference value.

In accordance with an example embodiment of the present invention, the first limiting value and the second limiting value are dependent on the determined lane width; the first limiting value and the second limiting value increase along with the increasing lane width; the first limiting value and the second limiting value increase non-linearly along with the lane width when the lane width falls short of a reference value; the first limiting value and the second limiting value increase linearly along with the lane width when the lane width (B) exceeds a reference value; and the first limiting value increases more than the second limiting value in the event that the lane width falls short of a reference value.

In accordance with an example embodiment of the present invention, the first limiting value increases as a cubic function of the lane width when the lane width falls short of the reference value, and/or the second limiting value increases as a quadratic function of the lane width when the lane width falls short of the reference value. The use of square and cubic functions has proven in driving tests to be suitable and is numerically particularly easy to implement.

An example embodiment of the present invention provides that the deviation variable is determined at least via a video sensor.

### BRIEF DESCRIPTION OF THE DRAWINGS

FIG. 1 shows a characteristic curve for maximum lateral control.

FIG. 2 shows a characteristic curve for minimum lateral control.

FIG. 3 shows the sequence of an example method according to the present invention.

### DETAILED DESCRIPTION

The present invention may be used for smoothly adapting the lateral-control support in motor vehicles to the lane width, thereby providing the driver with consistent lateral control on road lanes having narrower or wider than the average road lane width.

Certain parameters of the guidance characteristic curve are adapted for this purpose. The guidance characteristic curve describes the type of lateral control. The entire range from maximum vehicle lateral control with significant driver relief to minimum control with a pure lane departure function may be set on the roadway markings using this characteristic curve. The lane width adaptation of suitable characteristic curve parameters makes a similar or identical type of guidance on different lane widths possible. This makes an automatic adaptation of the vehicle lateral control possible on both wide roadways (e.g., highways) and narrow roadways (rural roadways). The driver may thus use his LKS system (lane keeping support system) for roadways having different widths, and thus the drive has an expanded utilization range of his system.

An LKS system may have different types of guidance. Two types of guidance are provided as examples.

Guidance Type 1: Maximum Guidance

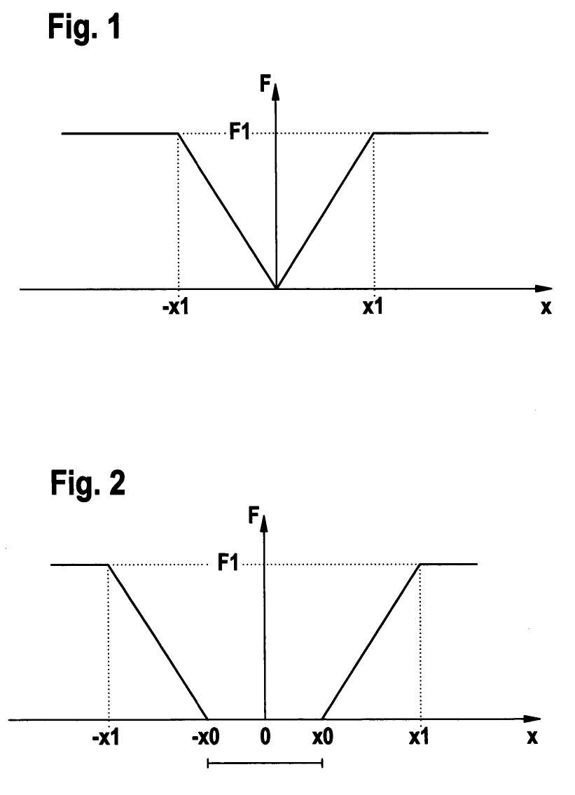

In this guidance type, maximum guidance of the vehicle in the center of the lane takes place and no (or at most minimal) deviations are tolerated, thereby significantly relieving the driver in his steering task. The linear guidance characteristic curve shown in FIG. 1 is suitable for such maximum lane guidance.

Difference x between the intended ideal line of the lane guidance and the actual, or driver-defined, vehicle movement is plotted in FIG. 1 in the abscissa direction. This difference x may be, for example, the vehicle's lateral displacement from the center of the lane, which is also referred to as “vehicle deviation.” Force F which acts on the steering wheel is plotted in the ordinate direction. Force F may also be a torque. F assumes the maximum value F1 for x=x1 and x=−x1.

Guidance Type 2: Minimum Guidance

If minimum guidance is requested from the LKS system, which does not relieve the driver of his steering task but rather only prevents departure from the lane upon contact with the lane boundary, the characteristic curve shown in FIG. 2, with a zone free of steering wheel forces extending from −x0 to x0, may be used.

The same variables are applied in FIGS. 1 and 2 along the axes.

The guidance characteristic curves shown in FIGS. 1 and 2 are only valid for one lane width and provide safe vehicle guidance for this case. It has been shown to be advantageous to: a) keep maximum value F0 of the steering wheel force constant, even when the lane width varies; and b) adapt values x0 and x1 to the current lane width.

Entire lane width B is determined by the lane-keeping support system. This may take place via analysis of video signals, for example. Parameters x0 and x1 are adapted to current lane width B via a comparison with a reference state.

A lane having width B_ref is considered as a reference state. For B=B_ref, parameter x0 and x1 assume values x0_ref and x1_ref.

The two cases of a lane having a lane width B>B_ref and a lane having a lane width B<B_ref are differentiated below.

Case 1: B>B ref (wide lane)

Parameters x0 and x1 may be determined based on the following simple linear relationships:
x0/x0_ref=B/B_ref and
x1/x1_ref=B/B_ref.

The values of x0 and x1 increase linearly with the lane width. This is also figuratively plausible since, along with an increasing width, a wider force-free zone (−x0<x<x0) as well as a slower increase of the steering wheel force may be accepted.

Case 2: B<B ref (narrow lane)

For the purpose of retaining safe lane guidance in narrow lanes, a non-linear adaptation has been shown to be suitable:
x0/x0_ref=(B/B_ref)^{n+m} and
x1/x1_ref=(B/B_ref)ⁿ.

Parameter n represents the adaptation degree. Furthermore, it has been found to be advantageous to adapt the values for the force-free zone to a greater degree than value x1. This is based on the fact that the existing lateral distance to the lane boundary is reduced in the case of a narrower lane. Increased adaptation for x0 takes place for m>0. It is advantageous to select: one of the values 2, 3, 4, 5, . . . for n; and one of the values 1, 2, 3, 4, . . . for m. In driving tests n=2 and m=1 proved to be a suitable value pair. It is noted that n=2 represents a square dependency of x1 on lane width B; n=2 and m=1 represent a cubic dependency of x0 on the lane width (since n+m=2+1=3).

For exceedingly narrow lane widths, the LKS function may be switched off for safety reasons. Using the above-described adaptation, all characteristic curve functions used for lateral control, and including the above-mentioned characteristic curve parameters, may be handled.

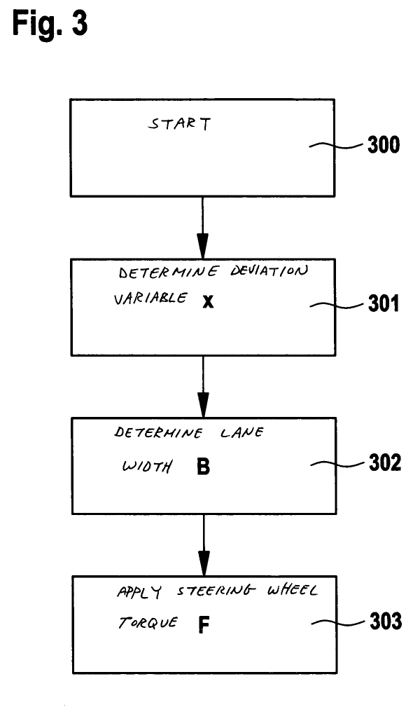

FIG. 3 shows the sequence of an example method according to the present invention. After the start in block 300, a deviation variable x, characterizing the lateral vehicle deviation or the deviation of vehicle trajectory from an ideal line, is determined in block 301. Lane width B is subsequently determined in block 302, followed by the exertion of a driver-independent steering wheel torque in block 303 as a function of the deviation variable and the lane width.

It should also be pointed out that the adaptation is not only applied to the positive values of x in the first quadrant of FIGS. 1 and 2, but also to the negative values of x.

What is claimed is:

1. A method for exerting a driver-independent steering-wheel torque on the steering wheel of a motor vehicle traveling in a lane, using a lane-keeping support system, comprising:
determining a width of the lane;
determining a deviation variable characterizing one of a lateral vehicle deviation from an ideal line and a lateral deviation of a vehicle trajectory from the ideal line; and
applying a steering-wheel torque that is dependent on the deviation variable and the width of the lane.

2. The method as recited in claim 1, wherein the ideal line is the center of the lane.

3. The method as recited in claim 1, wherein the deviation variable represent a difference between the ideal line and the vehicle trajectory.

4. The method as recited in claim 1, wherein no steering-wheel torque is exerted when the deviation variable does not exceed a first limiting value, and wherein the steering-wheel torque is exerted when the deviation variable exceeds the first limiting value.

5. The method as recited in claim 1, wherein, when the deviation variable exceeds the first limiting value, a steering-wheel torque that monotonically increases with the deviation variable is applied.

6. The method as recited in claim 5, wherein the steering-wheel torque is maintained at a constant value when the deviation variable is greater than or equal to a second limiting value, the first limiting value being less than the second limiting value.

7. The method as recited in claim 6, wherein the steering-wheel torque linearly increases with the deviation variable, if the deviation variable exceeds the first limiting value and falls short of the second limiting value.

8. The method as recited in claim 4, wherein the first limiting value is dependent on the determined width of the lane.

9. The method as recited in claim 8, wherein the first limiting value increases with an increase in the width of the lane.

10. The method as recited in claim 8, wherein the first limiting value increases non-linearly with an increase in the lane width when the lane width falls short of a reference value, and wherein the first limiting value increases linearly with an increase in the lane width when the lane width exceeds the reference value.

11. The method as recited in claim 10, wherein the first limiting value increases as a cubic function of the lane width when the lane width falls short of the reference value.

12. The method as recited in claim 6, wherein the second limiting value is dependent on the determined lane width.

13. The method as recited in claim 12, wherein the second limiting value increases with an increase in the lane width.

14. The method as recited in claim 12, wherein the second limiting value increases non-linearly with an increase in the lane width when the lane width falls short of a reference value, and wherein the second limiting value increases linearly with an increase in the lane width when the lane width exceeds the reference value.

15. The method as recited in claim 14, wherein the second limiting value increases as a quadratic function of the lane width as the lane width increase, if the lane width falls short of the reference value.

16. The method as recited in claim 6, wherein:
the first limiting value and the second limiting value are dependent on the determined width of the lane;
the first limiting value and the second limiting value increase with an increase in the lane width;
the first limiting value and the second limiting value increase non-linearly with an increase in the lane width when the lane width falls short of a reference value;
the first limiting value and the second limiting value increase linearly with an increase in the lane width when the lane width exceeds the reference value; and
the first limiting value increases more than the second limiting value in the event that the lane width falls short of the reference value.

17. The method as recited in claim 16, wherein the first limiting value increases as a cubic function of the lane width when the lane width falls short of the reference value, and wherein the second limiting value increases as a quadratic function of the lane width when the lane width falls short of the reference value.

18. The method as recited in claim 1, wherein the deviation variable is determined by using at least a video sensor.
